(19) United States
(12) Patent Application Publication
(10) Pub. No.: US 2025/0392396 A1
(43) Pub. Date: Dec. 25, 2025

(54) SYSTEM AND METHOD FOR OPTICAL COMMUNICATION USING POWER FEEDING LIGHT

(71) Applicant: NIPPON TELEGRAPH AND TELEPHONE CORPORATION, Tokyo (JP)

(72) Inventors: Hiroyuki IIDA, Musashino-shi, Tokyo (JP); Nobutomo HANZAWA, Musashino-shi, Tokyo (JP); Kazuhide NAKAJIMA, Musashino-shi, Tokyo (JP); Takashi MATSUI, Musashino-shi, Tokyo (JP); Yoko YAMASHITA, Musashino-shi, Tokyo (JP); Kohei OMOTO, Musashino-shi, Tokyo (JP); Kenji KUROKAWA, Kitami City, Hokkaido (JP)

(73) Assignee: NIPPON TELEGRAPH AND TELEPHONE CORPORATION, Tokyo (JP)

(21) Appl. No.: 18/880,539

(22) PCT Filed: Jul. 24, 2023
(86) PCT No.: PCT/JP2023/026939

§ 371 Date: Dec. 31, 2024

(30) Foreign Application Priority Data
Jul. 27, 2022 (JP) 2022-119544

(51) Int. Cl. H04B 10/80; G02B 6/02; H04B 10/25

(52) U.S. Cl. CPC H04B 10/807; G02B 6/02042; H04B 10/25

(57) ABSTRACT

The present disclosure is a system including a multi-core optical fiber that connects a plurality of devices, in which communication light is transmitted by using at least one core of a plurality of cores included in the multi-core optical fiber, power feeding light is transmitted by using at least one core of the plurality of cores included in the multi-core optical fiber, the core that transmits the power feeding light and the core that transmits the communication light, in the multi-core optical fiber, are different, and the multi-core optical fiber transmits the communication light and the power feeding light in a single mode or a pseudo single mode.

### TECHNICAL FIELD

The present disclosure relates to a system and a method for performing optical communication using power feeding light.

### BACKGROUND ART

A system that performs optical communication using power feeding light has been proposed (See, for example, Non-Patent Literatures 1 and 2.). In the first method disclosed in Non Patent Literature 1, two optical fibers are used, one of the two optical fibers is applied to optical power feeding, and the other optical fiber is applied to optical communication, and optical power feeding from a near-end device to a far-end device and bidirectional optical communication between the near-end device and the far-end device are performed. In this method, as the two optical fibers, two existing single mode optical fibers are used, or two existing multimode optical fibers are used, or both one existing single mode optical fiber and one existing multimode optical fiber are used.

In the second method disclosed in Non Patent Literature 1, by means of one existing single mode optical fiber or one existing multimode optical fiber in which power feeding light and communication light having different wavelengths are multiplexed, optical power feeding from the near-end device to the far-end device and bidirectional optical communication between the near-end device and the far-end device are performed.

In the third method disclosed in Non Patent Literature 2, by means of a double clad optical fiber/a few mode optical fiber that transmit power feeding light within a higher order mode/multimode range and communication light within a fundamental mode/single mode range, optical power feeding from a near-end device to a far-end device and bidirectional optical communication between the near-end device and the far-end device are performed. Here, the double clad optical fiber is an optical fiber in which ranges transmitting a higher order mode and a fundamental mode are multiplexed in an optical fiber cross section. Furthermore, the few mode optical fiber is an optical fiber having a structure in which multimode transmission is performed in a specific wavelength band and single mode transmission is performed in a wavelength band on a long wavelength side relative to the specific wavelength band.

The first method, which requires two optical fibers, complicates the system configuration and increases the cost.

In the second method, the single mode optical fiber limits an amount of optical power feeding to the far-end device due to an upper limit of the input optical power caused by the optical nonlinear effect, and the multimode optical fiber limits the communication speed and the transmission distance due to the characteristic degradation caused by the multimode transmission.

In the third method, an optical fiber structure is complicated, and a power feeding wavelength and a communication wavelength are constrained by the optical fiber structure. Furthermore, in a case where the communication wavelength is one wavelength, bidirectional simultaneous communication cannot be performed.

In the second and third methods, since the higher order mode/multimode range suitable for power feeding is generally on a short wavelength side, the communication wavelength band is degraded due to the Raman scattering characteristic caused by the power feeding wavelength.

### CITATION LIST

### Non Patent Literature

Non Patent Literature 1: Non Patent Literature 1: D. Wake et al., “Optically powered remote units for radio-over-fiber systems,” J. Lightw. Technol. 26, 2484-2491 (2008).

Non Patent Literature 2: M. Matsuura et al., “150-W power-over-fiber using double-clad fibers,” J. Lightw. Technol. 38, 401-408 (2020).

### SUMMARY OF INVENTION

### Technical Problem

An object of the present disclosure is to permit realization of optical power feeding and bidirectional optical communication, in which restrictions on an amount of optical power feeding are decreased, with one optical fiber.

### Solution to Problem

The present disclosure improves input restriction of power feeding light in an existing single-core single mode optical fiber, by utilizing a multi-core optical fiber for optical power feeding. Thereby, the present disclosure simultaneously realizes the optical power feeding from a near-end device to a far-end device and the bidirectional optical communication between the near-end device and the far-end device by means of the single mode optical fiber, and concurrently eliminates the restriction, caused by the single mode optical power feeding, on an amount of optical power feeding, and prevents the deterioration of communication wavelength characteristics caused by the multiplexing of a power feeding wavelength and a communication wavelength.

A system of the present disclosure includes a multi-core optical fiber that connects a plurality of devices, and the system executes a method of the present disclosure. The method of the present disclosure is a method executed by a system in which a plurality of devices is connected by a multi-core optical fiber, the method including: transmitting communication light by using at least one core of a plurality of cores included in the multi-core optical fiber; and transmitting power feeding light by using at least one core of the plurality of cores included in the multi-core optical fiber.

Here, in the present disclosure, the core that transmits the power feeding light and the core that transmits the communication light, in the multi-core optical fiber, are different. Furthermore, the multi-core optical fiber transmits the communication light and the power feeding light in a single mode or a pseudo single mode. As a result, the present disclosure permits realization of optical power feeding and bidirectional optical communication, in which the restriction on the amount of optical power feeding is decreased, with one optical fiber.

Furthermore, a wavelength of the communication light may be shorter than a wavelength of the power feeding light. In the present disclosure, the influence of Raman scattering, caused by the power feeding light, can be alleviated by setting the power feeding wavelength to a wavelength longer than the communication wavelength.

Furthermore, in the multi-core optical fiber, two or more cores may transmit the power feeding light. Thereby, a larger power can be obtained in the far-end device.

The far-end device that receives the power feeding light may include:
an optoelectronic conversion element that converts the light into electricity;
a transmitter that transmits the communication light by using power output from the optoelectronic conversion element; and
a receiver that receives the communication light by using power output from the optoelectronic conversion element.

The system of the present disclosure can adopt an embodiment in which the multi-core optical fiber includes four cores, the power feeding light is transmitted by using two of the four cores, and the communication light is transmitted in different transmission directions by using remaining two of the four cores.

The system of the present disclosure can adopt an embodiment in which the multi-core optical fiber includes four cores, the power feeding light is transmitted by using three of the four cores, and the communication light having different wavelengths is transmitted in different transmission directions by using a remaining one of the four cores.

Note that the above disclosures can be combined as much as possible.

### Advantageous Effects of Invention

The present disclosure can permit realization of optical power feeding and bidirectional optical communication, in which the restriction on the amount of optical power feeding is decreased, with one optical fiber.

### BRIEF DESCRIPTION OF DRAWINGS

FIG. 1 illustrates a system configuration example of the present disclosure.

FIG. 2 illustrates an example of optical characteristics of a multi-core optical fiber used in the present embodiment.

FIG. 3 illustrates dependency of power feeding light power in input, on the number of input cores.

FIG. 4 illustrates dependency of power posterior to OE conversion, on the number of input cores.

FIG. 5 illustrates dependency of a bit error rate of bidirectional communication on received light intensity.

FIG. 6 illustrates a system configuration example of the present disclosure.

### DESCRIPTION OF EMBODIMENTS

Hereinafter, embodiments of the present disclosure will be described in detail with reference to the drawings. Note that the present disclosure is not limited to the following embodiments. These implementation examples are merely illustrative, and the present disclosure can be implemented in a form with various modifications and improvements based on the knowledge of those skilled in the art. Note that components having the same reference signs in the present specification and the drawings indicate the same components.

### First Embodiment

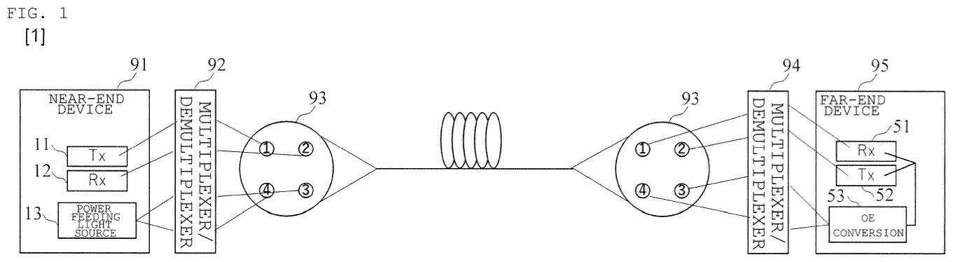

FIG. 1 illustrates a configuration diagram of a system of the present disclosure. The system of the present embodiment is a power feeding/bidirectional communication system in which a near-end device 91 and a far-end device 95 are connected by a multi-core optical fiber 93, and the near-end device 91 and the far-end device 95 perform bidirectional communication. Hereinafter, as an example, a power feeding/bidirectional communication system using a multi-core optical fiber 93 in which four cores, having optical characteristics equivalent to those of a normal single mode optical fiber, are arranged in a square lattice pattern in a clad having a diameter of 125 μm will be described.

The power feeding/bidirectional communication system of the present embodiment transmits communication light by using at least one of a plurality of cores included in the multi-core optical fiber 93, and transmits power feeding light by using at least one of the plurality of cores included in the multi-core optical fiber 93. For example, in the present embodiment, λ1 and λ2 are used as communication wavelengths of the communication light, and λ3 is used as a power feeding wavelength of the power feeding light. Here, in the power feeding/bidirectional communication system of the present disclosure, λ1 and λ2 are each set to a wavelength shorter than λ3, thereby avoiding the influence of Raman scattering caused by λ3.

For example, the near-end device 91 includes a transmitter (Tx) 11 for the wavelength λ1, a receiver (Rx) 12 for the wavelength λ2, and a power feeding light source 13 for the wavelength λ3. The power feeding light from the power feeding light source 13 is branched into two ports and connected to the first to fourth cores of the multi-core optical fiber 93 via the multiplexer/demultiplexer 92 together with ports for λ1 and λ2. For example, the transmitter 11 is connected to the first core, the receiver 12 is connected to the second core, and the power feeding light source 13 is connected to the third and fourth cores. As described above, in the present embodiment, in the multi-core optical fiber 93, any core that transmits the power feeding light and any core that transmits the communication light are different, and the communication light having different wavelengths is transmitted in different transmission directions by using the two cores.

Here, the multiplexer/demultiplexer 92 can use any means capable of coupling the four lights from the near-end device 91 to different cores, and examples thereof include a WDM coupler, a power coupler, and a Fan-In/Fan-Out (FIFO) device. The multiplexer/demultiplexer 94 can use any means capable of division for each core included in the multi-core optical fiber 93, and can use the same as the multiplexer/demultiplexer 92.

The far-end device 95 includes a receiver 51 for the wavelength λ1, a transmitter 52 for the wavelength λ2, and an optoelectronic (OE) conversion element 53 for the wavelength λ3. The devices/element are connected to the first to fourth cores of the multi-core optical fiber 93, separately. For example, the receiver 51 is connected to the first core, the transmitter 52 is connected to the second core, and the OE conversion element 53 is connected to the third and fourth cores.

Moreover, OE-converted power at the far-end device 95 is supplied as a power source for the receiver 51 and the transmitter 52 via suitable electrical circuitry. This configuration, even when the far-end device 95 is in a non-power supply state, can perform bidirectional communication by virtue of power feeding from the near-end device 91.

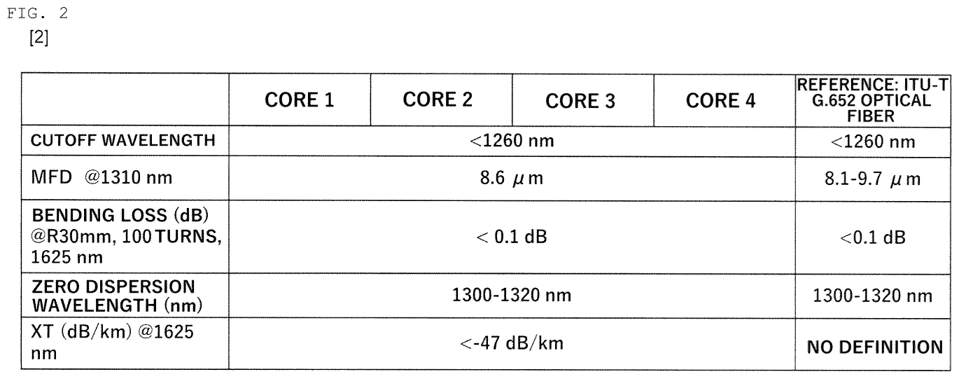

FIG. 2 illustrates an example of optical characteristics of the multi-core optical fiber 93 used in the present embodiment. In the present embodiment, a cutoff wavelength is less than 1260 nm, a mode field diameter (MFD) is 8.6 μm, a bending loss is less than 0.1 dB, a zero dispersion wavelength is 1300 nm or more and 1320 nm or less, and a crosstalk (XT) is less than −47 dB/km. Here, the MED indicates a value at 1310 nm, and the bending loss and the crosstalk indicate values at a wavelength of 1625 nm. Furthermore, the bending loss is a value in a state of being wound 100 times with a bending radius of 30 mm. Transmission characteristics of each core of the multi-core optical fiber 93 may be any optical characteristics as long as single mode or pseudo single mode transmission can be realized; from the standpoint of usability of existing general-purpose transmission/reception devices as repurposed items, each core, desirably, has optical characteristics equivalent to those of a general-purpose single mode optical fiber (for example, an optical fiber conformed to ITU-T Recommendations G.652).

The multi-core optical fiber 93 used in the first embodiment of the present disclosure has the sufficient optical characteristics conformed to ITU-T Recommendations G.652, and operates in a single mode at a wavelength of 1260 nm or more. Note that, although there is no definition of crosstalk in the existing optical fiber standard, feasibility of satisfactory transmission characteristics requires a wavelength bringing about crosstalk characteristics of approximately −20 dB or less at a reception end. The multi-core optical fiber 93 according to the present embodiment can achieve crosstalk characteristics of less than −40 dB at a wavelength of 1625 nm or less even after propagation of about 2.6 km.

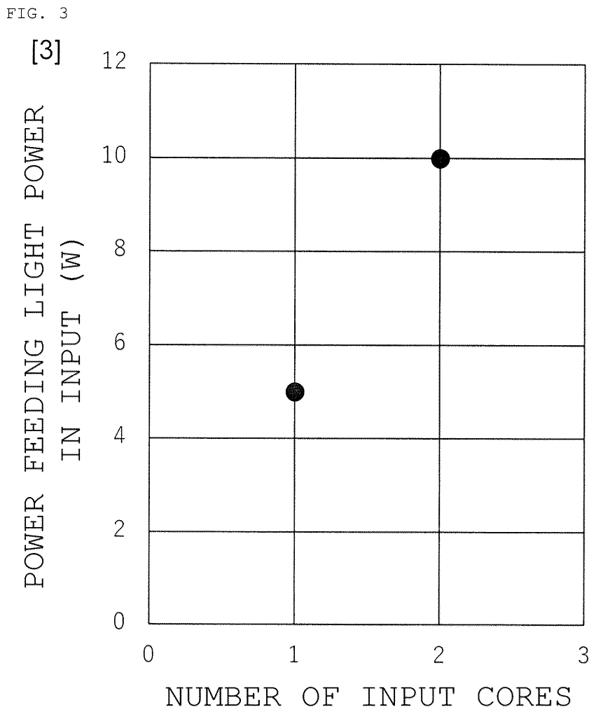

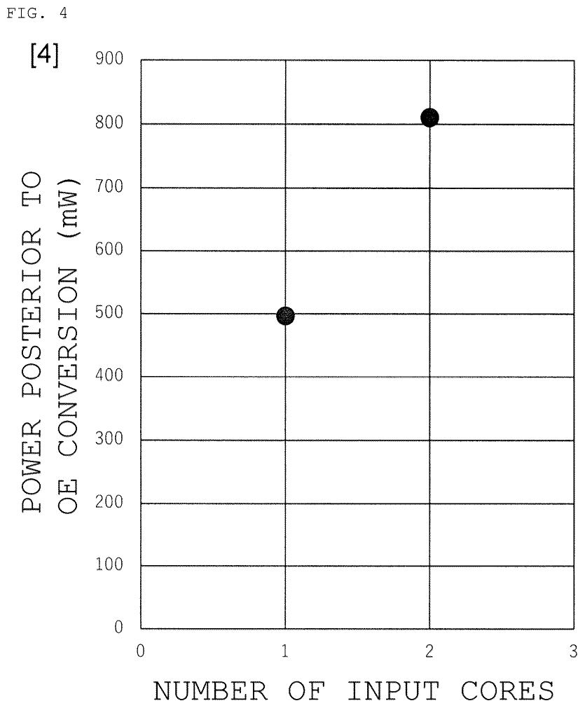

FIGS. 3 and 4 illustrate dependency of power feeding light power in input and power posterior to OE conversion, on the number of input cores. The power feeding light power in input is the total power feeding light power output from the power feeding light source 13 and input to the cores of the multi-core optical fiber 93. The power posterior to OE conversion power is power after the OE conversion in the far-end device 95. In the present embodiment, the power feeding wavelength is set to 1550 nm, and the transmission distance from the near-end device 91 to the far-end device 95 is set to 2.6 km.

As can be seen from FIGS. 3 and 4, distributing the power feeding light to the plurality of cores, for propagating the light, can bring about power feeding light and OE conversion voltage, obtained in the far-end device 95 that is a reception end, larger than using a single core brings about. The driving power of the receiver 51 and the transmitter 52 used in the present embodiment is 600 mW, and distributing the power feeding light to two cores can optically feed sufficient power to drive the receiver 51 and the transmitter 52 at a far end.

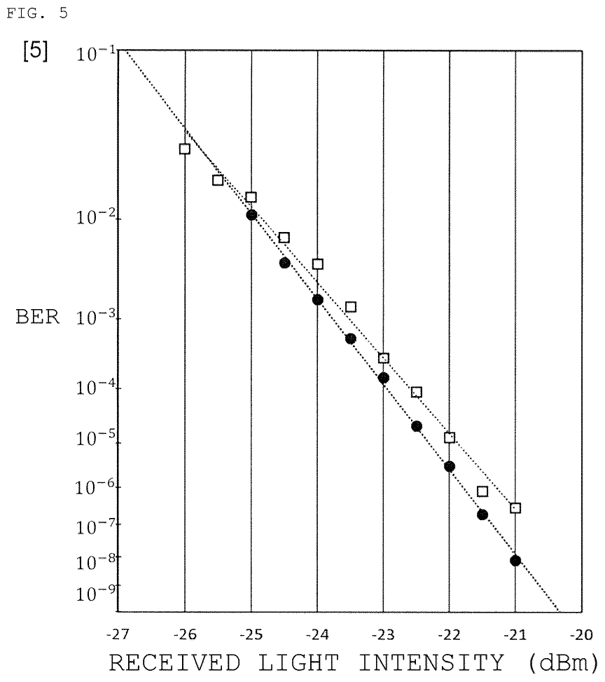

FIG. 5 illustrates dependency of a bit error rate (BER) of bidirectional communication on received light intensity. Here, the transmitter 11 and the receiver 12 were driven using a commercial power supply of the near-end device 91, and the receiver 51 and the transmitter 52 in a far-end device 95 side were driven using power obtained by the power feeding light. Note that transmission light is an intensity modulation signal of 1.25 Gbit/s, and a pseudo-random binary sequence (PRBS) is set to 2¹⁵-1. Furthermore, in the present embodiment, λ1 and λ2 are set to 1310 nm each.

In the drawing, indicates a bit error rate (BER) of a signal transmitted from the transmitter 11 included in the near-end device 91 and received by the receiver 51 included in the far-end device 95, and ● indicates a BER of a signal transmitted from the transmitter 52 included in the far-end device 95 and received by the receiver 12 included in the near-end device 91. Satisfactory transmission characteristics can be found to be realized even when the power feeding light is used.

### Second Embodiment

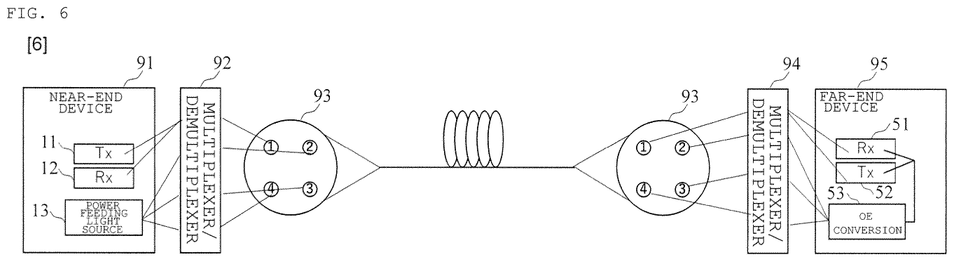

FIG. 6 illustrates a configuration diagram of a power feeding/bidirectional communication system according to a second embodiment of the present disclosure. In the power feeding/bidirectional communication system of the present embodiment, the configurations of a near-end device 91 and a far-end device 95 and the characteristics of a multi-core optical fiber 93 are similar to those of the first embodiment. However, a transmitter 11 and a receiver 12 are connected to a first core, and a power feeding light source 13 is connected to second, third, and fourth cores.

Power feeding light from the power feeding light source 13 is branched into three ports, and enters the second core to the fourth core of the multi-core optical fiber 93, and signal light propagating through the first core is connected to a transmitter 52 or a receiver 51, or both the receiver 51 and the transmitter 52 via a WDM coupler or the like.

Here, a communication wavelength between the transmitter 11 and the receiver 51 is A1, a communication wavelength between the transmitter 62 and the receiver 12 is λ2, and a power feeding wavelength is λ3. In the present embodiment, in the multi-core optical fiber 93, any core that transmits the power feeding light and the core that transmits the communication light are different, and the communication light having different wavelengths is transmitted in different transmission directions by using one core.

For example, assuming that λ1 is 1310 nm, λ2 is 1550 nm, and λ3 is 1560 nm, the Raman spectrum is generated at a wavelength longer than the power feeding wavelength by 100 nm, and a crosstalk component of the adjacent core increases at the longer wavelength. However, since λ1 and λ2 are each set to a wavelength shorter than λ3 is set, they are not affected by a crosstalk noise.

On the other hand, assuming that λ3 is set to a wavelength (for example, 1450 nm) shorter than λ2 is set or a wavelength (for example, 1160 nm) shorter than λ1 is set, signal light having λ2, with λ3 set to 1450 nm, or signal light having λ1, with λ3 set to 1160 nm, is degraded due to the crosstalk noise caused by the Raman spectral component of the power feeding wavelength.

Therefore, in the second embodiment, by setting λ1<λ2<λ3, suitable bidirectional communication can be realized.

Note that, in the multi-core optical fiber 93 described above, the four cores are arranged in a square lattice pattern in the clad having a diameter of 125 μm, but the clad diameter of the multi-core optical fiber 93 and the number and an arrangement of the cores, with which the clad diameter is equipped, can be selected at discretion. For example, the multi-core optical fiber 93 may include 5 or more cores such as 8 cores.

Furthermore, although the example in which the power feeding wavelength is only λ3 has been described, two or more power feeding wavelengths may be used. In this regard, the effect of the present disclosure can be obtained by making all the power feeding wavelengths longer than all the communications.

### REFERENCE SIGNS LIST

11, 52 transmitter
12, 51 receiver
13 power feeding light source
53 optoelectronic (OE) conversion element
91 near-end device
92, 94 multiplexer/demultiplexer
93 multi-core optical fiber
95 far-end device

1. A system comprising
a multi-core optical fiber that connects a plurality of devices,
wherein communication light is transmitted by using at least one core of a plurality of cores included in the multi-core optical fiber,
power feeding light is transmitted by using at least one core of the plurality of cores included in the multi-core optical fiber,
the core that transmits the power feeding light and the core that transmits the communication light, in the multi-core optical fiber, are different, and
the multi-core optical fiber transmits the communication light and the power feeding light in a single mode or a pseudo single mode.

2. The system according to claim 1, wherein
a wavelength of the communication light is shorter than a wavelength of the power feeding light.

3. The system according to claim 1, wherein
the power feeding light is transmitted by using two or more cores included in the multi-core optical fiber.

4. The system according to claim 1, wherein
a far-end device that receives the power feeding light comprises:
an optoelectronic conversion element that converts the light into electricity;
a transmitter that transmits the communication light by using power output from the optoelectronic conversion element; and
a receiver that receives the communication light by using power output from the optoelectronic conversion element.

5. The system according to claim 1, wherein
the multi-core optical fiber includes four cores,
the power feeding light is transmitted by using two of the four cores, and
the communication light is transmitted in different transmission directions by using remaining two of the four cores.

6. The system according to claim 1, wherein
the multi-core optical fiber includes four cores,
the power feeding light is transmitted by using three of the four cores, and
the communication light having different wavelengths is transmitted in different transmission directions by using a remaining one of the four cores.

7. A method executed by a system in which a plurality of devices is connected by a multi-core optical fiber, the method comprising:
transmitting communication light by using at least one core of a plurality of cores included in the multi-core optical fiber; and
transmitting power feeding light by using at least one core of the plurality of cores included in the multi-core optical fiber;
wherein the core that transmits power the feeding light and the core that transmits the communication light, in the multi-core optical fiber, are different; and
the multi-core optical fiber transmits the communication light and the power feeding light in a single mode or a pseudo single mode.
